(19) United States
(12) Patent Application Publication
(10) Pub. No.: US 2014/0130112 A1
(43) Pub. Date: May 8, 2014

(54) METHOD FOR ACCESSING A SERVICE, IN PARTICULAR A WEB PORTAL, BY MEANS OF A TERMINAL FOR REPLAYING A MULTIMEDIA STREAM

(71) Applicants: Halim Bendiab-Dallah, Vaucresson (FR); Roberto Agro, Bourg La Reine (FR)

(72) Inventors: Halim Bendiab-Dallah, Vaucresson (FR); Roberto Agro, Bourg La Reine (FR)

(73) Assignee: ORANGE, Paris (FR)

(21) Appl. No.: 14/008,846

(22) PCT Filed: Mar. 29, 2012
(86) PCT No.: PCT/FR12/50660

§ 371 Date: Sep. 30, 2013

(30) Foreign Application Priority Data
Mar. 31, 2011 (FR) 1152713

(51) Int. Cl. H04N 21/438; H04N 21/482

(52) U.S. Cl. CPC H04N 21/438; H04N 21/482
USPC 725/109

(57) ABSTRACT

A method is provided for accessing a service by a terminal for replaying a multimedia stream. The terminal performs the following steps: reception of the multimedia stream; detection, in the multimedia stream, of an item of information pertaining to access to a service; storage of the item of access information; association of the item of access information with a predefined man-machine interface element; and in the event of interaction of a user with the man-machine interface element, execution of an operation for access to the service using the item of access information.

### 1. CROSS-REFERENCE TO RELATED APPLICATIONS

This application is a Section 371 National Stage Application of International Application No. PCT/FR2012/050660, filed Mar. 29, 2012, which is incorporated by reference in its entirety and published as WO 2012/131258 on Oct. 4, 2012, not in English.

### 2. FIELD OF THE INVENTION

The field of the invention is that of a digital television (DTV).

In a digital television system, a multimedia transport stream is distributed by cable, satellite, terrestrial wireless or ADSL (Asymmetric Digital Subscriber Line). The multimedia transport stream contains one or more programs (also called services) as well as signaling tables. Each program (service) consists of one or more elementary streams (video streams, audio streams, data streams). The multimedia transport stream is broadcast towards users (final clients) who have a specific rendering terminal (also called a decoder or again a digital television receiver) that is integrated into a digital television set or provided in the form of a device (called a set-top box) attached to the digital television set.

More specifically, the invention pertains to a technique for accessing a service (especially but not exclusively a web portal) by means of a terminal for rendering a multimedia stream.

The present invention can be applied especially but not exclusively in the case of a multimedia transport stream compliant with MPEG-2 TS (Moving Picture Experts Group—2 Transport Stream) and DVB (Digital Video).

### 3. TECHNOLOGICAL BACKGROUND

We shall strive more specifically here below in this document to describe the set of problems existing in the case of access to a web portal by a rendering terminal for rendering a multimedia stream (a set of problems which the inventors of the present patent application have faced). The invention naturally is not restricted to this particular case of application but is of interest for access to any service whatsoever (for example a web page) by a terminal for rendering a multimedia stream.

There presently exist several techniques enabling access to a web portal from a terminal for rendering a multimedia stream.

A first known technique consists of the use of a television set connected to the Internet (this is also known as connected television). This technique proposes access to a multimedia web portal (with TV broadcasts, video, music, practical information, news, etc) by means of a direct access key on a remote control unit of the television set. Pressing this key generates an http request towards the URL address of the portal (this URL address is hardcoded into the connected television set).

In a second known technique, when a decoder (or set-top box) is connected to the digital television set, the remote control unit of the set-top box is used. Typically, access to a portal is obtained by means of an http request towards the URL address of the portal following the keying in, on the remote control unit of the decoder, of a number associated with the desired portal. Thus, the user can access several portals, each portal being associated with a distinct number.

One drawback common to the first and second known techniques is that they do not permit contextual access to a portal, i.e. access to a portal specific to the channel (program, service) being viewed. Indeed, the portal to which the first known technique enables access is always the same portal (for a given television set) whatever the television channel (program, service) being watched on the television set. Besides, the list of one or more portals which the user can access with the second known technique depends on the contents of the multimedia stream received by the set-top box but is not related to the television channel (program, service) being watched on the television set.

A third known technique is based on interactive television technology defined for example in the HBBTV (Hybrid Broadcast Broadband TV) standard which stipulates, for connected television sets and set-top boxes, the addition of information to be displayed on the screen of the television set while a user watches a television program (television channel). These pieces of information are either available directly in the multimedia stream (broadcast information) or delivered via a connection (return channel) between the terminal of the user (television set connected to the decoder) and server of the broadcaster or a third party operating in relation with the broadcaster (information transmitted via a point-to-point or broadband access). This must ultimately make it possible to cover all the uses generally offered by connected television sets: catch-up television, video on demand (VOD), interactive advertising, customizing, voting, games, social networks, program guides, etc.

An HBBTV terminal (i.e. a terminal compatible with the HBBTV standard) possesses a software architecture generally comprising system software above which interactive television middleware (iTV middleware) is executed.

In interactive television middleware, it is generally possible to distinguish a module for managing interactive applications (including a browser), a module for managing tables and a module for managing object carousels.

During the deployment of a given interactive application associated with a given program (television channel), the broadcaster transmits (within a given stream) the given program comprising:
elementary audio and/or video streams,
tables describing these elementary streams (PAT (Program Allocation Tables) and PMT (Program Map Tables) in particular,
constituent elements (software code especially, for example HTML code in the form of a web page) of a given interactive application transmitted for example within an object carousel encoded according to the DSM CC (Digital Storage Media Command and Control) standard,
an AIT (Application Information Table), identifying all the interactive applications available for the given program (including the given interactive application) as well as the way in which these interactive applications are available (object carousel in this case for the given interactive application).

When this given program is received, the HBBTV terminal displays the audio and video streams (through the tables describing them). Besides, within interactive television middleware, the table management module processes the AIT table and detects the fact that a software code of the given interactive application has been transmitted in an object carousel: the carousel management module receives and reassembles the constituent elements of the given interactive application; and the module for managing the applications manages the given interactive application (reassembled by the carousel management module). Like each interactive application, the last-named one can for example take one of the following states: loaded, paused, active or destroyed.

In one variant of the deployment of a given interactive application, the given program (broadcast) does not comprise the constituent elements of the given interactive application but the AIT table specifies a URL address at which the given interactive application can be obtained. Within the interactive television middleware of the HBBTV terminal, there are the following actions: the table management module processes the AIT table and obtains this URL address; the browser of the applications management module sends a request to this URL address in order to receive the given interactive application; and the applications management module manages the given interactive application.

The current rules of management stipulate that only one interactive application at a time can be displayed on the screen of the television set (it can be overlaid on the video of the current TV program but not on the content of another interactive application). Furthermore, the installation and start-up procedures are designed to work entirely automatically without interaction by the user.

To access a web portal from an HBBTV terminal, the current HBBTV standard proposes the following first technical mode of operation (based on the above-mentioned variant in which the AIT specifies a URL address at which the given interactive application can be obtained):
the broadcaster of a program (television channel) sends a particular URL address in an AIT (Application Information Table) of its stream. This URL address, to again use the above terminology, is that of an interactive application (the role of which herein is to enable access to a portal), but is not the address of the portal itself;
when the HBBTV terminal detects this particular URL address, it automatically sends a server a first request for access to this particular URL address;
in response to this first request, the server sends the HBBTV terminal the requested interactive application which is a first page, the execution of which on the browser of the terminal prompts the display (on the screen of the television set) of a window containing a message or a logo (a small red dot for example) informing the user that a portal (or any unspecified service) is available and requesting the user to access it by pressing a particular key (for example the “OK” key) of the remote control unit of the HBBTV terminal;
if the user presses this particular key, the HBBTV terminal sends the server a second request for access to the URL address of the portal;
in response to this second request, the server sends the HBBTV terminal the requested portal which is a second page, the execution of which on the browser of the terminal prompts the display (on the screen of the television set) of elements (windows, menus, etc) proposing one or more services to the user.

To access a web portal from an HBBTV terminal, the current HBBTV standard also proposes the following second technical mode of operation (based on the basic mode mentioned here above in which the AIT table specifies that a software code of the given interactive application has been transmitted to an object carousel conveyed by this stream):
the broadcaster of a program sends a command, in an AIT table of its stream, for extracting a particular interactive application in an object carousel (to repeat the above terminology, this particular interactive application comprises a function of access to a portal but is not the portal itself);
when the HBBTV terminal detects an extraction command, it automatically retrieves the requested interactive application which is a first page (transmitted in the stream), the execution of which, on the browser of the terminal, prompts the display (on the screen of the television set) of a window containing a message or a logo (a little red dot for example) informing the user that a portal (or any unspecified service) is available and requesting him to access it by pressing a particular key (for example the “OK” key) of the remote control unit of the HBBTV terminal;
if the user presses this particular key, the HBBTV terminal sends the server a request for accessing the URL address of the portal;
in response to this request, the server sends the HBBTV terminal the requested portal which is a second page, the execution of which on the browser of the terminal prompts the display (on the screen of the television set) of elements (windows, menus, etc) proposing one or more services to the user.

In each of the first and second above-mentioned technical modes of operation proposed in the current HBBTV standard, after the portal has been displayed on the television screen, the pair formed by the HBBTV terminal and the television set then enables browsing in a web content available (on one or more servers) and only in this web content (with the possibility of proposing selected web pages, in consultation mode only). The broadcaster retains full control over the web content that is made accessible (the displayed content is entirely controlled by the broadcaster and is generally contextual in relation to the program in progress). The user at any time can leave the interactive mode (browsing in the web content) to return to his television program.

One advantage of the above-mentioned first and second modes of operation of the current HBBTV standard is that it enables contextual access to a portal, i.e. access to a portal specific to the channel (program) being viewed on the screen of the television set.

By contrast, they have the drawback of being incapable of associating the following applications with a same program:
a classic interactive application (the term “classic” is understood to mean an application that does not seek to offer access to a portal), and
a particular interactive application proposing access to a portal (according to the above-mentioned basic mode or variant).

Indeed, if this were to be the case, each interactive application being automatically started up and only one interactive application being capable of being displayed at a time (see above-mentioned rules), the starting of the particular interactive application (proposing access to a portal) would automatically lead to closure of the classic interactive application (games application or voting application for example).

It is important to note that, in the above-mentioned first mode of operation, the URL address of the portal cannot be directly inserted into the AIT table. Indeed, this would lead the HBBTV terminal to automatically send the server a request for access to the URL address of the portal and, upon a response from the server, it would prompt the unconditional display of the portal on the television screen (overlaid on the video of the current TV broadcast or even displayed instead of this current TV broadcast).

Similarly, in the above-mentioned second operation, it is not possible to directly insert a command, into the AIT for extracting from the portal (the portal being in this case transmitted in a carousel of objects, in the stream). Indeed, this would lead the HBBTV terminal to automatically and unconditionally display the portal on the television screen (overlaid on the video of the current TV broadcast or even displayed instead of it).

Another drawback of the above-mentioned first and second embodiments is that they generate visual discomfort for the user. Indeed, any zapping by the user on a television channel (program) associated with a particular interactive application proposing access to a portal leads to the display (overlaid on the current TV program) of a window containing a message or a logo informing the user that access to a portal is possible by pressing a key (“OK” key for example) of the remote control unit of the HBBTV terminal.

Another drawback of the above-mentioned first mode of operation is that it generates unnecessary requests and therefore a non-optimal management of the bandwidth of the network through which the HBBTV terminal and the server are connected. Indeed if, after the display of the window containing the invitation to access a portal, the user decides not to access the portal, then it means that the first request to the server as well as the sending by the server of the first page (the execution of which on the browser of the terminal causes the display of this invitation to access the portal) were transmitted unnecessarily.

### 4. SUMMARY OF THE INVENTION

One particular embodiment of the invention proposes a method of access to a service by a terminal for rendering a multimedia stream. Said terminal performs the following steps:
receiving the multimedia stream;
detecting, in the multimedia stream, a piece of access information for accessing a service;
storing said piece of access information;
associating said piece of access information with a predefined man-machine interface element; and
in case of interaction of a user with said man-machine interface element, executing an operation of access to said service using said piece of access information.

The general principle of the invention therefore consists of the insertion of a piece of access information (for example the URL address of a portal) directly into the stream and in providing, in the rendering terminal, for a particular processing mechanism for processing the said piece of access information (this particular processing information performs a detection, a storage and an association of this piece of access information with a man-machine interface element).

Thus, this piece of access information is not processed by the rendering terminal like a classic interactive application and its reception causes no inconvenient display on the television screen (overlay on the video of the current TV transmission, or even instead of the current transmission) nor any dispatch of an unnecessary request to the server. Furthermore, the reception and processing of this access information does not disturb the classic processing (for example according to the HBBTV standard as described here above) of a classic interactive application.

The piece of access information can be seen as a novel type of interactive application dedicated to an access to a service (this service being for example a portal) distinct from the interactive types of application already known to date.

Furthermore, since the piece of access information is inserted into the multimedia stream, it can be dynamically changed, especially when the content of the multimedia stream changes: thus, this information can be contextual, i.e. proper to the content currently broadcast via this multimedia stream.

Besides, the man-machine interface element can be chosen independently of the content broadcast via the multimedia stream: this element is unique, common for example to all the television channels and/or to all the contents broadcast via this multimedia stream and therefore easily storable by the user who at any time can interact with this element in order to determine whether an access to a service is proposed for the content that he receives via this multimedia stream.

Finally, since the piece of access information is inserted into the multimedia stream, it can be modified at any time or updated by the device that generates this multimedia stream. This piece of access information can of course also be proper to a television channel or else proper to a content (transmission, film, etc) being broadcast via this television channel. Each service provider generating a set of audiovisual contents broadcast via this multimedia stream can therefore customize this piece of access information at will depending on what he wishes to propose at a given point in time to the user of the receiver terminal of this multimedia stream.

Finally, the invention can be applied as much to the broadcasting of video streams and audiovisual streams as to video-less audio streams provided that these streams are conveyed in transport format enabling the encoding of the access information and its extraction by a receiver terminal.

According to one particular characteristic, said service is a portal for access to at least one other service.

In this way, the broadcaster of a digital TV channel (program) can offer his portal in a live broadcast.

According to one particular characteristic, the piece of access information is:
either a connection address for connection to a server implementing said service in a communications network, said operation comprising a sending of a connection request to said server using said connection address;
or a command for extracting a software code of an interactive application inserted in said multimedia stream and comprising a function of access to said service, said operation comprising an execution of said software code.

Thus, the concept proposed can be used whatever the nature of the piece of access information transmitted in the stream.

According to one particular characteristic, said man-machine interface element is a key of said terminal or a key of a remote control unit associated with said terminal.

Thus, a single key enables the user to access a service (for example a portal) of the TV channel being viewed. For example, if the user is on key number corresponding to the French TF1 channel, he directly accesses the TF1 portal when he presses this key. The same applies if he is on the France2 channel or any other TV channel which wishes to propose its own portal (offering its own services: games, votes, etc).

According to one particular characteristic, in the event of interaction by a user with said man-machine interface element, if no access information has been detected, said terminal performs a step for inhibiting the execution of said operation.

Thus, the invention prevents inappropriate access to a service (for example a portal) which is not linked to the TV channel being viewed.

According to one particular characteristic, in the event of interaction of a user with said man-machine interface element, if no piece of access information has been detected, said terminal provides a piece of information on the impossibility of executing said operation.

The information on the impossibility of executing said operation is for example an error message and/or an information message on the absence of access information.

Thus, if there is no information to the contrary, the user knows that he can access a service (for example a portal) not linked to the TV channel being viewed.

According to one particular characteristic, the access information is inserted into a signaling table, included in said multimedia stream, this signaling cable comprising a field for describing a predetermined value indicating that this signaling table comprises a piece of access information.

Thus, the existing notion of signaling tables included in the multimedia streams is advantageously reutilized.

According to one particular characteristic, said multimedia stream comprises several signaling cables each comprising a piece of access information, each said signaling table possessing a version number. The access information included in said signaling table is ignored in said step for detecting a piece of access information if the signaling table considered possesses a version number equal to or previous to that of a previously received signaling table.

This simplifies the processing operations performed by the rendering terminal.

According to one particular characteristic, the multimedia stream is encoded in compliance with the MPEG-2 TS standard. The signaling table comprising a piece of access information is an AIT (Application Information Table) of a particular type indicating that it comprises a piece of access information. The step for detecting comprises the following steps: detecting the AIT of said particular type, and reading the piece of access information included in the AIT of said particular type.

Thus, the implementing of the technique proposed is facilitated by relying on the AIT and more specifically by proposing a novel type of AIT (not provided for in current versions of the DVB and HBBTV standards).

According to one particular characteristic, the AIT of said particular type is defined in a PMT (Program Map Table) by:
a transport unit identifier (PID);
a “stream type” field taking the value 0x05; and
an “application_signalling_descriptor( )”, of which an “application_type” field takes
a predetermined value specific to said particular type of AIT.

This is therefore quite simply a novel type of AIT that is being defined, to be used according to the proposed technique to enable access to a service (a portal for example) specific to the TV channel being viewed.

According to one particular characteristic, during the access to said service, said terminal carries out a step for inhibiting the execution of any interactive application identified in a received AIT that does not possess said particular type.

For example, so long as the access operation is being executed, for example so long as the user browses within the portal (or within a domain accessible via the portal), this browsing session cannot be interrupted unexpectedly by a (classic) interactive application transmitted by the multimedia contents in progress (and which the user has left in order to access the portal).

According to one particular characteristic, the multimedia stream comprises at least two distinct multimedia contents, including one current multimedia content. Said terminal performs the following steps:
detecting, for at least one multimedia content included in the multimedia stream, a piece of information for accessing a service;
storing a piece of access information, detected in association with an identification of multimedia content for which this piece of access information has been detected; and
associating, with said man-machine interface element, the piece of access information detected for the current multimedia content via said multimedia stream;
   furthermore, at each change in current multimedia content, the terminal reiterates the step for associating, with said man-machine interface element, the piece of access information stored for the current multimedia content.

According to one particular characteristic of the method of access, the multimedia streams comprise at least two distinct multimedia contents, including one current multimedia content, said terminal performs the steps for detecting and storing a piece of access information for each of said multimedia contents and, at each change of current multimedia content, the terminal reiterates the step for associating, with said man-machine interface element, the access information stored for the current multimedia content.

The term “current multimedia content” is understood to mean the content selected by the user and displayed on the television set (or the content selected by default, for example in the case of the channel displayed when the set is started).

Thus, when at least two distinct multimedia contents are broadcast (successively or simultaneously), via multimedia streams (for example two television channels, or else two broadcasts made via a same television channel), it is possible to manage a piece of access information in association with each of these contents.

For example, when the user zaps from one television channel to another (changing a current television channel), the rendering terminal manages the change of access information more rapidly in that it has already memorized a piece of access information for the newly selected channel that is proper to this channel (for example the URL address of a portal associated with the newly selected channel).

The piece of access information proper to a channel is memorized for example when the user selects this channel with the remote control unit of the terminal. The pieces of access information associated with the different channels are in this case stored one by one as and when the zapping is done by the user. In one variant, several pieces of information on access, each associated with a distinct channel, are stored at the same time, independently of the zapping by the user, for example during a capture of the list of multiplexed channels within the multiplexed stream. In other words, in this variant, in the stream, pieces of access information are detected associated with different channels but only the piece of access information associated with the current channel (the network being viewed on the television set) is associated with the man-machine interface element (the “portal key” for example).

According to one particular characteristic, the method of access comprises the following steps:
detecting an elimination command in the multimedia stream; and
eliminating said association after detecting said elimination command.

Another embodiment of the invention proposes a method for generating a multimedia stream to be transmitted to a rendering terminal, characterized in that it comprises a step for inserting a piece of access information, for access to a service, into the multimedia stream, said piece of access information being intended for being:
detected by the rendering terminal following the reception of the multimedia stream;
associated by the rendering terminal with a man-machine interface element, and
used by the rendering terminal, in the event of interaction of a user with said man-machine interface element, to execute an operation of access to said service.

Another embodiment of the invention proposes a computer program product comprising program code instructions to implement the above-mentioned method (in any one of its different embodiments) when said program is executed on a computer.

Another embodiment of the invention proposes a computer-readable storage medium, storing a computer program comprising a set of instructions executable by a computer to implement the above-mentioned method (in any one of its different embodiments).

Another embodiment of the invention proposes a terminal for rendering a multimedia stream comprising:
means for receiving the multimedia stream;
means for detecting, in a multimedia stream, a piece of access information for accessing a service;
means for storing said access information;
means for associating said piece of access information with a predefined man-machine interface element; and
means, activated in the event of interaction of a user with said man-machine interface element, for executing an operation of access to said service using said access information.

Another embodiment of the invention proposes a device for generating a multimedia stream to be transmitted to a rendering terminal, characterized in that it comprises means for the insertion, into the multimedia stream, of a piece of access information for accessing a service, said piece of access information being intended for being:
detected by the rendering terminal following the reception of the multimedia stream;
associated by the rendering terminal with a man-machine interface element and
used by the rendering terminal, in the event of interaction of a user with said man-machine interface element, to execute an operation of access to said service.

Another embodiment of the invention proposes a signal conveying a multimedia stream, intended for being transmitted to a rendering terminal. The multimedia stream comprises a piece of access information for accessing a service, said piece of access information being intended to be:
detected by the rendering terminal following the reception of the multimedia stream,
associated by the rendering terminal with a man-machine interface element and
used by the rendering terminal, in the event of interaction of a user with said man-machine interface element, to execute an operation of access to said service.

### 5. LIST OF FIGURES

Other features and advantages of the invention shall appear from the following description, given by way of an indicative and non-exhaustive example, and from the appended drawings, of which:

FIG. 1 presents a block diagram of a system according to one particular embodiment of the invention; and

FIG. 2 presents a graph of a sequence showing an example of kinematics of the processing of a piece of access information for access to a portal by the system of FIG. 1.

### 6. DETAILED DESCRIPTION

In all the figures of the present document, the identical elements and steps are designated by a same numerical reference.

Here below in the description, it is assumed by way of a non-exhaustive example that the multimedia transport stream is compliant with the MPEG-2 TS and DVB standards.

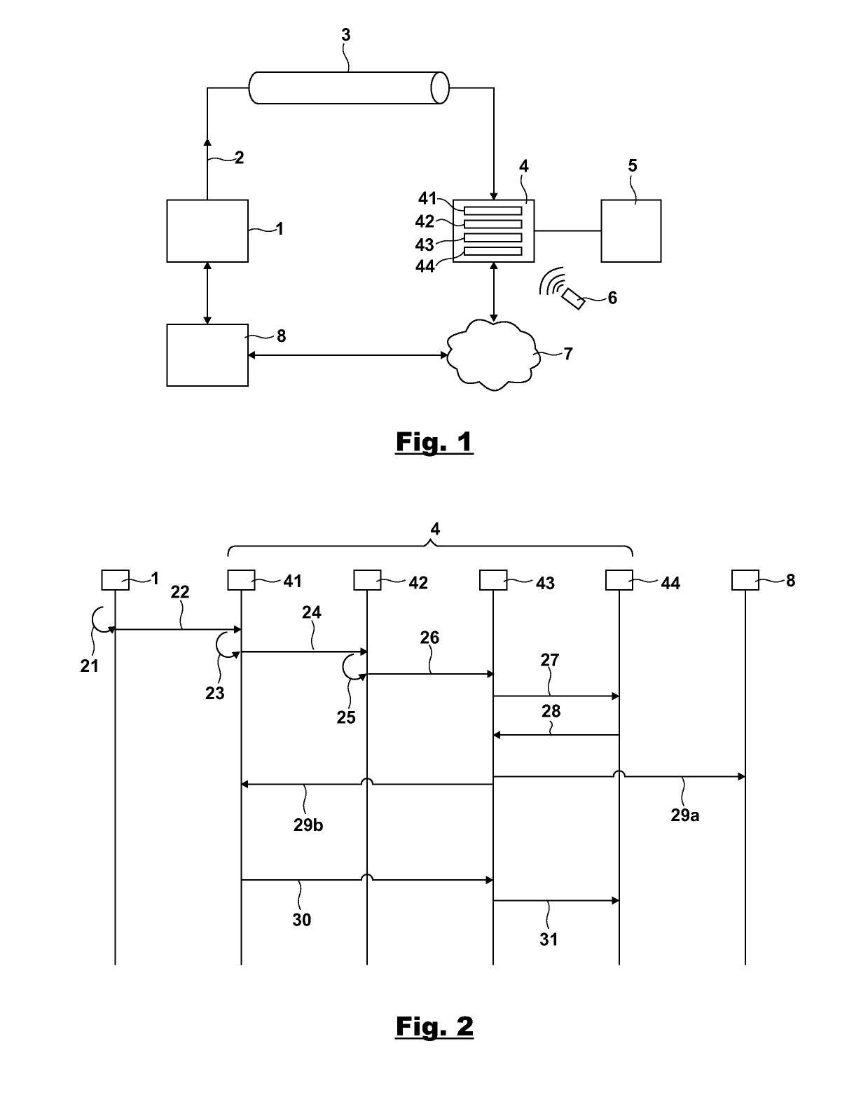

Referring now to FIG. 1, we present a system according to one particular embodiment of the invention. This system comprises:
a broadcasting control room 1 managed by a broadcaster and enabling the broadcasting of a multimedia transport stream 2 via a broadcasting network 3 (using one or more of the following technologies: cable, satellite, terrestrial wireless or ADSL);
a plurality of decoders (also called rendering terminals or set-top boxes) 4 (for the sake of simplicity in FIG. 1, only one decoder is shown therein) receiving the multimedia transport stream 2;
a television set 5 connected to a decoder 4 (in one variant the rendering terminal is integrated with the television set and it is the television set that is connected to the Internet 7);
a remote control unit 6 associated with the decoder 4;
a web server 8 with which the decoder 4 can communicate, via a communications network 7 (the Internet for example). The application server 8 is optionally connected to the broadcasting control room 1 (via any unspecified link).

Here below in the description, it is assumed as a non-exhaustive example that the broadcaster of the multimedia transport stream 2 wishes to propose direct access to the service, for example a web portal hosted by the web server 8, this service being specific to a particular content broadcast via this multimedia stream, for example to a television channel. Direct access is to be proposed, for example, to the portal “OrangeReplay” (whose URL address is http://www.orange_replay.fr) which is specific to the Orange television channel.

It is clear however that the invention is not limited to this example and can be applied to all cases where it is sought to propose direct access to a service (not necessarily a portal) which is on the one hand accessible via a communications network (the Internet for example) to which a rendering terminal (decoder or connected television set) is connected and, on the other hand, specific to a content broadcast within a multimedia transport stream.

The principle of operation can be summarized as follows. In order to propose direct access to a service (to the web portal) specific to a content (a particular television channel) of the multimedia transport stream 2, the broadcasting control room 1 comprises means enabling the insertion, into the multimedia transport stream 2 and more specifically into a particular signaling table, of a piece of information providing access to this service, this piece of access information being for example a connection address for connection to the server 8 implementing this service, an address which can be encoded in URL form. The decoder 4, which, through the multimedia stream, receives a particular television channel rendered on the television set 5 and viewed by a user, extracts the access information presented in the stream 2 and associates it with a man-machine interface element of the decoder. This element is for example a key of the remote control unit of the decoder which is dedicated to this type of access to a service. This key will here below be called a “portal key”. This means that, at any time, this user, by pressing on the “portal key”, can access the web portal defined by the broadcaster of this particular television channel, by means of a user interface displayed on the television set 5 (overlaid on or replacing the video of the television channel being viewed). The user can disconnect at any time from the portal (or from the web browsing domain, i.e. a set of web pages accessible from the portal), for example by again pressing the same “portal key”. In this case, he returns to the same television channel (the one associated with the portal being left by the user), i.e. on the television set 5, he again views only the video of the television channel which he was viewing when he pressed the “portal key” for the first time.

There are various means for transmitting the access information to a service in a transport stream compliant with the MPEG-2 TS standard. It is possible for example to define a private signaling table or to use an already existing DVB signaling table.

We now present a particular embodiment in which the description relies on the AIT (Application Information Table) defined in the DVB standard. More specifically, the invention proposes a novel type of AIT here below called a “portal AIT” which contains information on access to a service.

We may briefly recall the use, as stipulated in the DVB standard, of the PAT (Program Allocation Table), PMT (Program Map Table) and AIT signaling tables.

The PAT table conveys the list of all the programs (services) present in the MPEG-2 TS stream. Each listed program is identified by a program number (16 bits) and is associated with the identifier (or PID, or Packet Identifier) of the transport packets conveying the PMT sub-table corresponding to this program.

The PMT table describes the components of each program (service) in associating, with each component, the identifier (PID) of the transport packets that convey this component. The MEPG-2 TS stream comprises one PMT sub-table per program. The components of a program are the elementary streams (video elementary streams, audio elementary streams, etc) and signaling tables (especially the AIT table).

The PMT table of a given program therefore gives especially the identifier (PID) of the transport packets which convey the AIT table associated with this given program. One AIT table is broadcast for each program (service) of the MPEG2-TS stream that conveys one or more interactive programs and provides information on the characteristics of this interactive application or applications.

In a PMT table, each component of a program is described especially by a “stream_type” description field which indicates the type of component. For an AIT type of component, the value of the “stream_type” field is equal to 0x05 and it is associated with a descriptor known as the “application_signalling_descriptor”. This descriptor is the following:

```
application_signalling_descriptor( )
{
      descriptor_tag
      descriptor_length
      for( i=0; i<N; i++ )
      {
              reserved_future_use
              application_type
              reserved_future_use
              AIT_version_number
      }
}
```

The “application_type” description field makes it possible to specify the type of interactive application for the AIT table concerned (i.e. the type of interactive application or applications whose characteristics are indicated by the AIT table concerned). It takes for example a first value to indicate a type of interactive application compliant with the HBBTV standard, a second value to indicate a type of interactive application compliant with the MHP (Multimedia Home Platform) standard, etc.

This particular embodiment of the invention proposes that a predetermined value (included for example in the range of private or non-reserved values) of the “application_type” description field should be associated with a novel type of interactive application, thus making it possible to define a new type of AIT table (AIT portal table) enabling the transport of a piece of information for access to a service (for example the URL address of a portal) and to manage the mode of access to this service by means of this access information.

Thus, this prevents any conflict at reception (on the decoder side), between a classic AIT table (i.e. a table providing information on the characteristics one or more interactive applications compliant with the HBBTV or MHP standard) and a “Portal AIT table” according to the present invention.

We now present an example of an embodiment of the “portal AIT table” according to the invention. The “portal AIT table” contains a set of descriptors describing the nature of the information for accessing a service but also the mode of access to this service depending on the nature of this access information. The descriptors are:
a descriptor giving information on the nature of the access information and the access mode, called the “application_descriptor” which contains information on the profile of the application. We can distinguish for example two profiles: the first indicates that the portal is transmitted according to the object carousel technique and the second indicates that only the URL address of the portal is transmitted; and
a descriptor giving information on access information, called a “transport_protocol_descriptor” that contains the URL address of the portal (if the “application_descriptor” indicates the second profile) or a command for extraction from the portal in an object carousel (if the descriptor “application_descriptor” indicates the first profile).

More specifically, if the “application_descriptor” indicates the second profile, the “transport_protocol_descriptor” is the following:

```
transport_protocol_descriptor( )
{
      descriptor_tag = 0x02
      descriptor_length
      protocol_id = 0x03
      transport_protocol_label
      for(i=0; i<N; i++)
      {
              selector_byte = “http://www.orange_replay.fr”
      }
}
```

The “descriptor_tag” field is equal to 0x02 by definition in the standard since it is a “transport_protocol_descriptor” type of descriptor. This enables the terminal to identify it as such.

The “protocol_id” field takes for example the value 0x03 in order to indicate that the “selector byte” information is of the URL type.

The “selector byte” field contains a connection address for connection to the server implementing the proposed service, in this case the URL address, of the portal.

To define a carousel object, the “protocol_id” field takes a predetermined value in order to indicate that the “selector byte” information is of the URL type.

Referring now to FIG. 2, we describe an example of kinematics of the processing of piece of access information for accessing a portal by the system of FIG. 1.

It is assumed in this example that the access information is a URL of the portal and is transmitted in the “portal AIT table” according to the invention (see above description).

The decoder 4 (cf. FIG. 1) comprises several functional blocks (also called modules) and especially:
a module 41 for decoding/demultiplexing the stream 2, used to detect the presence of a “portal AIT table”;
a module 42 for reading the “portal AIT table” enabling the extraction, storage or elimination of a piece of access information (URL address or the like) contained in a “portal AIT table”;
a module 43 for access to the portal; and
a module 44 for managing the “portal key” of the remote control unit of the decoder.

Each of the functional blocks (modules) of the decoder 4 can be made equally well on a reprogrammable computing machine (a PC computer, a DSP processor or a microcontroller) executing a program comprising a sequence of instructions or on a dedicated computation machine (for example a set of logic gates such as an FPGA or an ASIC or any other hardware module). If a functional block is made on a reprogrammable computation machine, the corresponding program (i.e. the sequence of instructions) can be stored in a storage medium that is detachable, such as for example a floppy disk, a CD-ROM or a DVD-ROM) or non-detachable, this storage medium being partially or totally readable by a computer or a processor.

The example of kinematics is now described in detail. It is assumed in this example that the television channel Orange seeks to give access to its portal “OrangeReplay” (the URL address of which is http://www.orange_replay.fr).

In FIG. 2, the different steps are represented by arrows each associated with a digital reference.

In the step 21, the broadcasting control room 1 inserts a “portal AIT table” into the stream. This “portal AIT table” is associated with the Orange television channel and contains the URL address of the portal of this channel.

In the step 22, the broadcasting control room 1 broadcasts the stream received by the decoding/demultiplexing module 41 (included in the decoder 4).

At the step 23, during a zapping on the Orange channel, the module 21 for decoding/demultiplexing decodes and demultiplexes the stream in order to detect a “portal AIT” associated with the Orange channel.

If the module 41 for decoding/demultiplexing has detected a “portal AIT table”, it gives this information to the module 42 for reading the “portal AIT table” in the step 24.

In the step 25, the reading module 42 demultiplexes the “portal AIT table” associated with the Orange channel (if the version number of this table is different from that of a previously received “portal AIT table” and extracts the URL address of the portal from it, then stores this URL address.

In the step 26, the reading module 42 transmits this URL address to the module 43 for access to the portal.

In the step 27, the module 43 for access to the portal associates this URL address with the “portal key” and activates the module 44 for managing the “portal key”. An association between the piece of access information (the URL address) and the man/machine interface element (the “portal key”) is thus memorized by the module 43 for access to the portal with a view to subsequent use of this piece of access information in the event of interaction with the man/machine interface element concerned.

When several man/machine interface elements could be concerned, an identification of the man/machine interface element is memorized in association with the access information.

At the step 28, if the module 44 for managing the “portal key” detects pressure on this key, it informs the module 43 for access to the portal thereof.

At the step 29a, the module 43 for access to the portal obtains the access information (URL address) stored in association with the man/machine interface element (“portal key”) for which an interaction has been detected. Then the module 43 for access to the portal uses the access information to execute an access operation: the module 43 for access to the portal sends an http request to the server 8 comprising the access information stored, in order to access the portal identified by this piece of access information and enable browsing by the user on this portal.

In parallel, at the step 29b, the module 43 for access to the portal sends a command to the decoding/demultiplexing module 41 so that this module inhibits the execution of any interactive application described/contained in a classic AIT table so that no interactive application of an HBBTV or MHP type for example is executed by the decoder so long as the user accesses the portal, i.e. so long as he is browsing on the portal or in a web browsing domain—i.e. a set of web pages accessible from the portal and defined by the broadcaster of the Orange channel.

If the decoding/demultiplexing module 41 has not received a “portal AIT table” containing access information, it informs the module 43 for access to the portal about it in the step 30.

In the step 31, the module 43 for access to the portal deactivates the module 44 for managing the “portal key” and displays a message or a logo on the screen of the television set, indicating that the “portal key” is not activated.

In one particular embodiment, to enable speedier management of the access to the portals associated with the different television channels, the URL addresses of the different portals are stored in a cache memory by the decoder as and when the user changes channels. In other words, at the time of reception, via the broadcast stream, of a given television channel, the access information, in the form of URL addresses of the portal associated with this channel, is saved by the decoder in association with an identification of the channel (for example a number corresponding to the channel broadcast). The access information associated with a channel is thus preserved in memory even when there is a change of channel and when the current channel is different from the channel for which the previous information access had been memorized. The access information which will be used following an interaction on a man/machine interface element will then be the one memorized in association with the channel currently being viewed by the user.

Thus, at each zapping (change of channel viewed by the user on the television screen), the decoder can immediately associate the URL address of the portal associated with the new channel being viewed with the “portal key”. This prevents waiting for the reception of access information for the new current channel.

This principle of association can be applied more generally to broadcasting via a multimedia stream of several distinct multimedia contents, for example the contents coming from two distinct sources: contents broadcast via two distinct television channels as described here above, or else more generally via two distinct transmission services for transmitting audio and/or video content (radio, video on demand, catch-up television service, etc).

In each case, the decoder receiving the multimedia stream stores a piece of access information received during the broadcasting of the content considered in association with an identification of the content currently distributed and/or the source of this content. This identification is formed for example from the number associated with the television channel or an identifier of services for retransmitting audio content and/or any other mode of identification available (for example an identification of a function activated to access this content of the “activate channel x”, “access VOD service”, or other types).

Then, at each change of multimedia source/content currently broadcast, whether this change is requested by the user or planned by the functioning of the decoder, the decoder identifies the content and/or the source of the newly selected content (in searching for example for the television channel currently selected or the service for transmitting audio content and/or video content currently selected or an identification of an activated function to access this content). It then reiterates the step of association, with the “portal key,” of the access information recorded for this content and/or this source.

This principle of association is also applicable when two distinct contents are broadcast successively via the multimedia stream while at the same time forming part of a same television channel and/or same service for transmitting audio and/or video content. In this case, the content can be identified by means of metadata or programming data of the content (title of the content, author, time of start of broadcasting, etc).

In one embodiment, it is planned to send an AIT table in the multimedia stream. This AIT table comprises an elimination command to eliminate a preliminarily memorized association between the currently broadcast content (for example the current television channel or current program/video/audio content broadcast via this television channel or via a service for broadcasting audio/video content) via the multimedia stream and the man/machine interface element (“portal key”). Upon reception of such a command, the module 41 for decoding/demultiplexing informs the module 42 for reading the “portal AIT table” about it thereof. This module 42 eliminates the memorized association. Then, the module 43 deactivates the module 44 for managing the “portal key”.

It can furthermore be planned to interrupt any ongoing access to the service for which the stored association has been eliminated. It is thus possible to prohibit access to a service at any time.

1. A method of access to a service by a terminal for rendering a multimedia stream during which said terminal performs the following steps:
receiving the multimedia stream;
detecting, in the multimedia stream, a piece of access information for accessing a service;
storing said piece of access information;
associating said piece of access information with a predefined man-machine interface element; and
in case of interaction of a user with said man-machine interface element, executing an operation of access to said service using said piece of access information.

2. The method according to claim 1, wherein said service is a portal for access to at least one other service.

3. The method according to claim 1, wherein the piece of access information is a connection address for connection to a server implementing said service in a communications network, said operation comprising a sending of a connection request to said server using said connection address.

4. The method according to claim 1, wherein the access information is a command for extracting a software code of an interactive application, inserted in said multimedia stream and comprising a function of access to said service, said operation comprising an execution of said software code.

5. The method according to claim 1, wherein said man-machine interface element is a key of said terminal or a key of a remote control unit associated with said terminal.

6. The method according to claim 1, wherein, in the event of interaction by a user with said man-machine interface element, if no access information has been detected, said terminal performs a step of inhibiting the execution of said operation.

7. The method according to claim 6, wherein, in the event of interaction of a user with said man-machine interface element, if no piece of access information has been detected, said terminal provides a piece of information on the impossibility of executing said operation.

8. The method according to claim 1, wherein the access information is inserted into a signaling table, included in said multimedia stream, this signaling cable comprising a field for describing a predetermined value indicating that this signaling table comprises a piece of access information

9. The method according to claim 8, wherein said multimedia stream comprises several signaling cables each comprising a piece of access information, each said signaling table possessing a version number, and the access information included in said signaling table is ignored in said step of detecting a piece of access information if the signaling table considered possesses a version number equal to or previous to that of a previously received signaling table.

10. The method according to claim 8, wherein the multimedia stream is encoded in compliance with the MPEG-2 TS standard, the signaling table comprising a piece of access information is an AIT (Application Information Table) of a particular type indicating that it comprises a piece of access information, and the step of detecting comprises the following steps: detecting the AIT of said particular type, and reading the piece of access information included in the AIT of said particular type.

11. The method according to claim 10, wherein the AIT of said particular type is defined in a PMT (Program Map Table) by:
a transport unit identifier (PID);
a “stream type” field taking the value 0x05; and
an “application_signalling_descriptor( )”, of which an “application_type” field takes a predetermined value specific to said particular type of AIT.

12. The method according to claim 10 wherein, during the access to said service, said terminal carries out a step of inhibiting the execution of any interactive application identified in a received AIT that does not possess said particular type.

13. The method according to claim 1, wherein the multimedia stream comprises at least two distinct multimedia contents, including one current multimedia content, said terminal performs the steps for detecting and storing a piece of access information for each of said multimedia contents and, at each change of current multimedia content, the terminal reiterates the step for of associating, with said man-machine interface element, the access information stored the current multimedia content.

14. The method according to claim 1, comprising the following steps:
detecting an elimination command in the multimedia stream; and
eliminating said association after detecting said elimination command.

15. A method for generating a multimedia stream to be transmitted to a rendering terminal, wherein the method comprises:
a step of inserting a piece of access information, for access to a service, into the multimedia stream, said piece of access information being configured for being:
detected by the rendering terminal following the reception of the multimedia stream;
associated by the rendering terminal with a man-machine interface element, and
used by the rendering terminal, in the event of interaction of a user with said man-machine interface element, to execute an operation of access to said service; and
a step of transmitting the multimedia stream to the rendering terminal.

16. (canceled)

17. (canceled)

18. A terminal for rendering a multimedia stream, wherein the terminal comprises:
means for receiving the multimedia stream;
means for detecting, in the multimedia stream, a piece of access information for accessing a service;
means for storing said access information;
means for associating said piece of access information with a predefined man-machine interface element; and
means, activated in the event of interaction of a user with said man-machine interface element, for executing an operation of access to said service using said access information.

19. (canceled)

20. (canceled)
